(19) United States
(12) Patent Application Publication
(10) Pub. No.: US 2005/0263040 A1
(43) Pub. Date: Dec. 1, 2005

(54) Steering Wheel Desk (Driver's Desk)

(76) Inventor: Martin Harold Kludjian SR., Dublin, CA (US)

Correspondence Address: MARTIN H. KLUDJIAN, 6588 AMADOR VALLEY BOULEVARD, DUBLIN, CA, 94568, US

(21) Appl. No.: 10/709,760

(22) Filed: May 26, 2004

(51) Int. Cl. A47B 23/00; A47B 37/00; B60K 17/344

(52) U.S. Cl. 108/44

(57) ABSTRACT

A lightweight, portable, easily installed and releasable, temporary desk to be hung on a steering wheel for use as a support for any purpose desired by the user. It has two integral hangers at the top to attach it to the steering wheel and one integral ledge at the bottom for supporting any object. The work surface is smooth to allow for writing. This desk is made from one flat piece of either plastic or metal with a total of three bends.

### BACKGROUND OF INVENTION

There are other devices previously patented, however they have different characteristics, which makes mine unique.

Easterly's device is different because it has no ledge upon which items can rest.

Mitchell's device is different because it has no ledge upon which items can rest.

Russell's device is different because it has multiple components and it's working surface is not parallel to to plane of the steering wheel.

Shioda's device is different because it it basically a clipboard.

Callahan's device is different because it has multiple components and it's surfaces have holes and slots which would make writing difficult when over the undulations. it's design is basically that of a clipboard per his claim with adjustable angled working surface.

Metcalf's device is different because it is only a support frame.

Breuner's device is different because it has multiple components and it's working surface is not parallel to to plane of the steering wheel.

Raasch's device is different because of it's method of attachment and it's working surface is not parallel to to plane of the steering wheel.

Lee's device is different because it is a tray.

Lippert's device is different because it has multiple components and a work surface that is not parallel to the steering wheel.

Rioux's device is different because it is collapsible and does not have a smooth flat surface.

### SUMMARY OF INVENTION

This device hangs on the top of the steering wheel and is used to support objects for the operator when in the driver's seat of a vehicle.

This device is used to hold a PDA, laptop computer, reading or writing material, and provide a smooth surface for writing or any other use desired while allowing the user to remain in a comfortable position.

### BRIEF DESCRIPTION OF DRAWINGS

FIG. 1 is a front view when installed on a steering wheel.

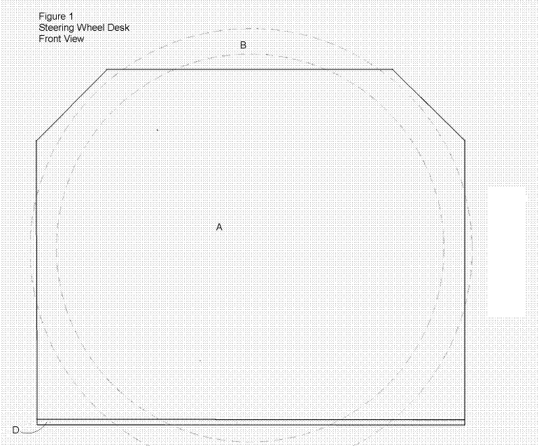

FIG. 2 is a side view when installed on a steering wheel.

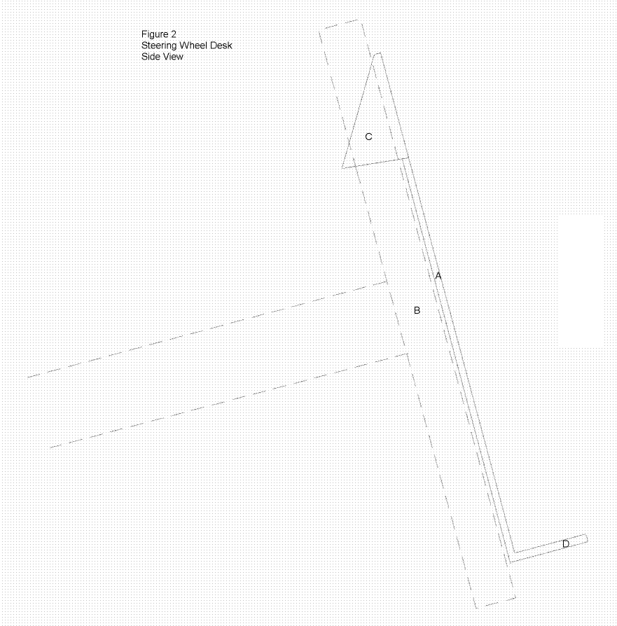

FIG. 3 is a rear view.

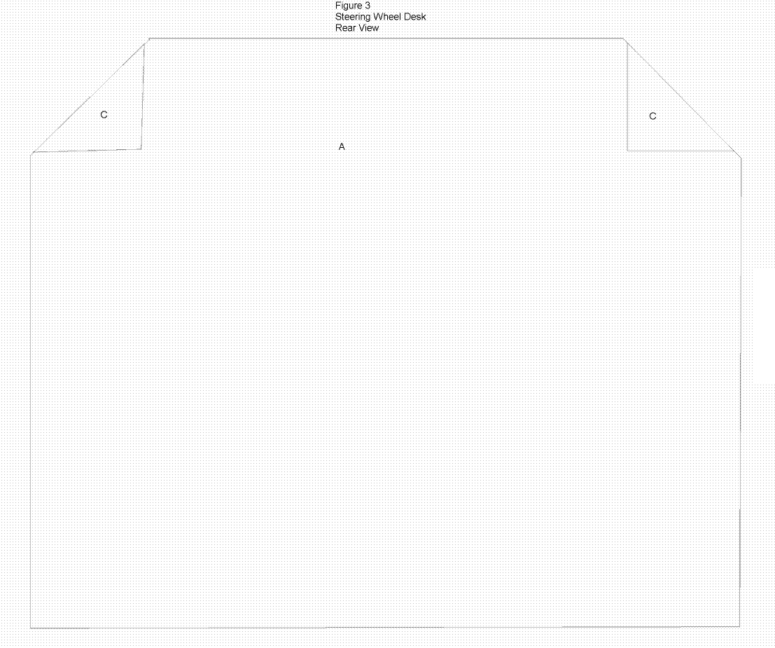

### DETAILED DESCRIPTION

This device is made from one flat (A) rectangular or square piece of material. One side is bent at approximately 90 degrees to become the support ledge (D). The other 2 corners (C) are bent diagonally towards each other and opposite direction to the ledge, and become the hangers. The hangers (C) are bent at approximately 135 degrees to provide for attachment to the steering wheel (B).

1. A steering wheel desk having a smooth flat surface free of holes or slots, with two integral hangers at the top, and an integral support ledge at the bottom.

2. The device recited in claim 1 has hangers that are unique in design due to the angle of approximately 135 degrees allowing the device to be instantly positioned correctly over a variety of diameters and shapes of steering wheels. This allows for attachment to the steering wheel to be snug and wobble free.
